(19) United States
(12) Patent Application Publication
(10) Pub. No.: US 2012/0106765 A1
(43) Pub. Date: May 3, 2012

(54) LOUDSPEAKER SYSTEM AND WAVESHAPING UNIT

(76) Inventor: Jörg Knieschewski, Garbsen (DE)

(21) Appl. No.: 13/380,134

(22) PCT Filed: Jun. 24, 2010
(86) PCT No.: PCT/EP10/59004

§ 371 Date: Jan. 12, 2012

(30) Foreign Application Priority Data
Jun. 25, 2009 (DE) 10-2009-027-212.7

(51) Int. Cl. H04R 1/20

(52) U.S. Cl. 381/337

(57) ABSTRACT

The invention concerns a loudspeaker system having a plurality of segmented line array speakers and a plurality of acoustic waveshapers. In addition there is provided an overlap region between two adjacent waveshapers.

The present application claims priority from PCT Patent Application No. PCT/EP2010/059004 filed on Jun. 24, 2010, which claims priority from German Patent Application No. DE 10 2009 027 212.7 filed on Jun. 25, 2009, the disclosures of which are incorporated herein by reference in their entirety.

### BACKGROUND OF THE INVENTION

1. Field of the Invention

The present invention concerns a loudspeaker system and a waveshaping unit.

2. Description of Related Art

Loudspeaker segments with segmented line array speakers and waveshapers (waveguides) are used in acoustic installations That permits sound propagation in the form of a cylindrical wave, which can reduce the propagation attenuation.

U.S. Pat. No. 5,900,593 shows a loudspeaker system with segmented line array speakers and waveshapers. The configuration of the waveshapers in particular at their transitions can however lead to interference.

U.S. Pat. No. 5,163,167 shows a loudspeaker system with waveguides. In that case various waveguides can be arranged one above or one beside the other. In this case also interference can occur in the transitional region between two waveguides.

As general state of the art attention is directed to the documents US 2005/0265570 A1 and US 2004/0245042 A1.

### SUMMARY OF THE INVENTION

An object of the present invention is to provide a loudspeaker system having a plurality of line array speakers and waveshapers which have reduced susceptibility to interference.

Thus there is provided a loudspeaker system having a plurality of segmented line array speakers and a plurality of acoustic waveshapers. In addition there is provided at least one overlap region between two adjacent waveshapers.

In an aspect of the present invention the overlap region is achieved by the oppositely disposed ends of the waveshapers being of a bevelled configuration.

In a further aspect of the invention the overlap region is achieved by the oppositely disposed ends of two waveshapers being of a stepped configuration and engaging into each other.

In a further aspect of the invention the overlap region is achieved by an end of a first waveshaper extending into a complementary end of the second waveshaper.

In a further aspect of the invention there is provided a waveshaper unit for a loudspeaker system having a plurality of segmented line array speakers. The waveshaper unit has at least two adjacent waveshapers and an overlap region between the at least two adjacent waveshapers.

The invention concerns the notion of providing an overlap region between two adjacent line array speakers or waveshapers. The provision of an overlap region between two adjacent waveshapers means that it is possible to permit a substantially constant quick acoustic behaviour. In addition interference which occurs by virtue of the transitions between adjacent line array speakers can be reduced by the provision of the overlap regions.

Further configurations of the invention are subject-matter of the appendant claims.

### BRIEF DESCRIPTION OF THE DRAWINGS

FIG. 1 shows a diagrammatic side view of a loudspeaker system according to the state of the art;

FIG. 2 shows a diagrammatic side view of a loudspeaker system according to a first embodiment;

FIG. 3 shows a portion on an enlarged scale of FIG. 2 according to the first embodiment;

FIG. 4A shows a perspective view of a portion of a loudspeaker system according to a second embodiment;

FIG. 4B shows a perspective view of a portion of a loudspeaker system according to a third embodiment; and

FIG. 4C shows a perspective view of a portion of a loudspeaker system according to a fourth embodiment.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

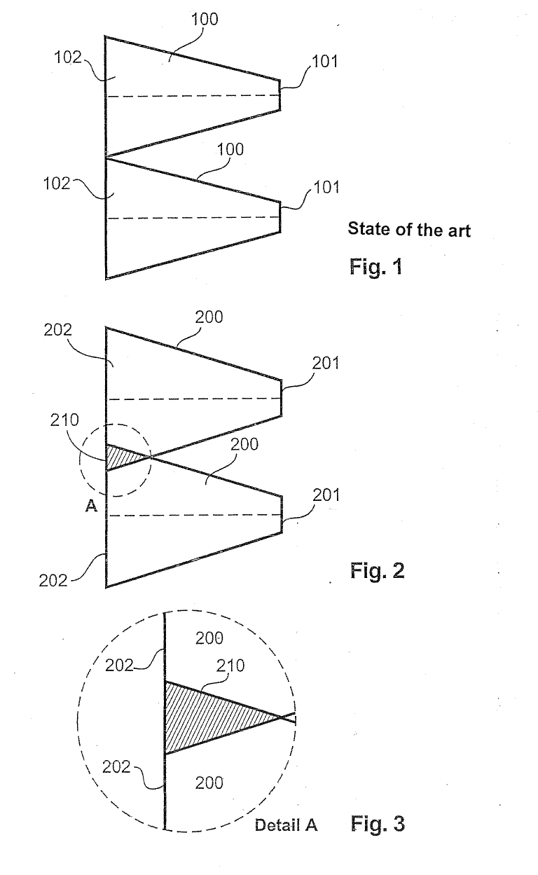

FIG. 1 shows a diagrammatic side view of a loudspeaker system according to the state of the art. In this case two adjacent segmented line array speakers 100 or the acoustic waveshaper of the line array speaker are shown. The waveshaper 200 has first and second ends 101 and 102. A loudspeaker is provided at the first ends 101. That loudspeaker produces for example a spherical wave which is converted into a plane wave in the waveshapers 100.

FIG. 2 shows a diagrammatic sectional view of a loudspeaker system according to a first embodiment. The loudspeaker system has segmented line array speakers with acoustic waveshapers 200. The acoustic waveshapers 200 have first and second ends 201, 202. A loudspeaker is provided at the first end 201. The loudspeaker produces for example a spherical wave which is converted into a plane wave in the waveshapers 200. In the first embodiment two adjacent waveshapers 200 have an overlap region 210. In other words the housings of the waveshapers have an overlap portion or a superimposition portion.

FIG. 3 shows a view on an enlarged scale of a portion of the loudspeaker system of FIG. 2. The overlap region 210 is shown on a larger scale here. While in the loudspeaker system in accordance with the state of the art in FIG. 1 there is no overlap of the waveshapers, the first embodiment is distinguished in that there is such an overlap region.

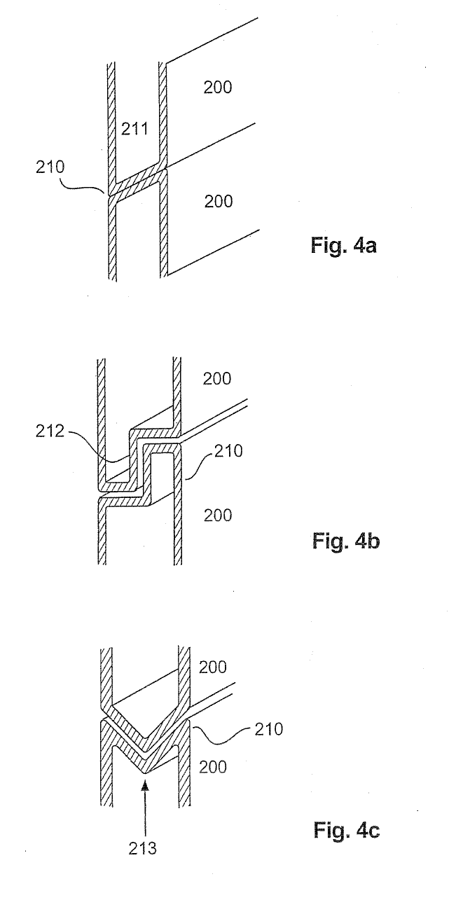

FIG. 4A shows a perspective view of a part of a loudspeaker system according to a second embodiment. Here the overlap region 210 is of such a configuration that the adjacent waveshapers 200 are of an inclined configuration or are cut off inclinedly at their oppositely disposed ends.

FIG. 4B shows a perspective of a part of a loudspeaker according to the third embodiment. Here the third embodiment is based on the first embodiment. The overlap region is of a stepped configuration in accordance with the third embodiment.

FIG. 4C shows a perspective of a part of a loudspeaker according to a fourth embodiment. In this case the loudspeaker system according to the fourth embodiment is based on the loudspeaker system according to the first embodiment. The overlap region 210 is of such a configuration that an end is in the form of an arrow tip and the adjacent waveshaper has an end of a corresponding configuration for receiving the arrow-shaped end.

The loudspeaker system according to the invention can have a multiplicity of segmented line array speakers.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defamed in the following claims.

1. A loudspeaker system comprising:
at least one segmented line array speaker with at least two acoustic waveshapers;
wherein the least two acoustic waveshapers each have a first end and a second end;
wherein a respective loudspeaker is provided at each of the first ends, each loudspeaker producing an acoustic wave which is converted in the waveshaper;
wherein an overlap region is provided between the at least two acoustic waveshapers.

2. The loudspeaker system as set forth in claim 1;
wherein the overlap region is achieved by mutually opposite ends of the at least two acoustic waveshapers having a bevelled configuration.

3. The loudspeaker system as set forth in claim 1;
wherein the overlap region is achieved by mutually opposite ends of the at least two acoustic waveshapers having stepped configuration.

4. The loudspeaker system as set forth in claim 1;
wherein the overlap region is configured so that a first end of a first waveshaper of the at least two acoustic waveshapers extends into a second end of a second waveshaper of the at least two acoustic waveshapers.

5. A waveshaper unit for a loudspeaker system comprising:
at least two adjacent waveshapers, each having a first end and a second end, where each first end is adapted to be connected to a loudspeaker; and
an overlap region between the at least two waveshapers.
